(19) United States
(12) Patent Application Publication
(10) Pub. No.: US 2025/0232061 A1
(43) Pub. Date: Jul. 17, 2025

(54) SYSTEM AND METHOD FOR SECURING ELECTRONIC IDENTITY DATA USING ELECTRONIC DATA OBFUSCATION AND MASKING

(71) Applicant: BANK OF AMERICA CORPORATION, Charlotte, NC (US)

(72) Inventors: George Anthony Albero, Charlotte, NC (US); Maharaj Mukherjee, Poughkeepsie, NY (US)

(73) Assignee: BANK OF AMERICA CORPORATION, Charlotte, NC (US)

(21) Appl. No.: 18/412,254

(22) Filed: Jan. 12, 2024

(51) Int. Cl. G06F 21/62; G06F 21/32

(52) U.S. Cl. CPC G06F 21/6254; G06F 21/32

(57) ABSTRACT

A system is provided for securing electronic identity data using electronic data obfuscation and masking. In particular, the system may comprise a networked environment comprising a database of unique characteristic identifiers, where each unique characteristic identifier may be associated with an entity or individual. In addition, the database may comprise a plurality of decoy identifiers that may be generated by a scrambling engine through one or more modifying operations on one or more unique characteristic identifiers. Furthermore, the unique characteristic identifiers within the database may be encrypted or converted from the “raw” unique characteristic data that may be stored offline. In this way, the system may provide a way to obfuscate legitimate unique characteristic data within the database to increase the security of the data stored therein.

### TECHNOLOGICAL FIELD

Example embodiments of the present disclosure relate to a system for securing electronic identity data using electronic data obfuscation and masking.

### BACKGROUND

There is a need for a secure, reliable way to automatically protect unique characteristic information.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for securing electronic identity data (e.g., unique characteristic information) using electronic data obfuscation and masking. In particular, the system may comprise a networked environment comprising a database of unique characteristic identifiers (e.g., biometric identifiers), where each unique characteristic identifier may be associated with an entity or individual. In addition, the database may comprise a plurality of decoy identifiers that may be generated by a scrambling engine through one or more modifying operations on one or more unique characteristic identifiers. Furthermore, the unique characteristic identifiers within the database may be encrypted or converted from the “raw” unique characteristic data that may be stored offline (e.g., outside of the database). In this way, the system may provide a way to obfuscate legitimate unique characteristic data within the database to increase the security of the data stored therein.

Accordingly, embodiments of the present disclosure provide a system for securing electronic identity data using electronic data obfuscation and masking, the system comprising a processing device; a non-transitory storage device containing instructions when executed by the processing device, causes the processing device to perform the steps of receiving one or more unique characteristic identifiers from an endpoint computing device; identifying, using an identifier scrambling engine, one or more features of the one or more unique characteristic identifiers; generating, using an identifier scrambling engine, a plurality of decoy identifiers based on the one or more unique characteristic identifiers, wherein each of the plurality of decoy identifiers comprises a randomized modification to the one or more features of the one or more unique characteristic identifiers; and storing the one or more unique characteristic identifiers and the plurality of decoy identifiers within a unique characteristic identifier database.

In some embodiments, the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

In some embodiments, the one or more unique characteristic identifiers comprises a fingerprint scan, wherein the randomized modification to the one or more features of the one or more unique characteristic identifiers comprises a change to a ridge or valley of the fingerprint scan.

In some embodiments, the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

In some embodiments, the identifier scrambling engine is an artificial intelligence (“AI”) engine, wherein identifying the one or more features of the one or more unique characteristic identifiers comprises performing AI-based detection of the one or more features.

In some embodiments, the randomized modification is performed using a generative AI based process.

In some embodiments, the endpoint device is a mobile device of a user, wherein the one or more unique characteristic identifiers are captured from the user through the mobile device.

Embodiments of the present disclosure also provide a computer program product for securing electronic identity data using electronic data obfuscation and masking, the computer program product comprising a non-transitory computer-readable medium comprising code causing an apparatus to perform the steps of receiving one or more unique characteristic identifiers from an endpoint computing device; identifying, using an identifier scrambling engine, one or more features of the one or more unique characteristic identifiers; generating, using an identifier scrambling engine, a plurality of decoy identifiers based on the one or more unique characteristic identifiers, wherein each of the plurality of decoy identifiers comprises a randomized modification to the one or more features of the one or more unique characteristic identifiers; and storing the one or more unique characteristic identifiers and the plurality of decoy identifiers within a unique characteristic identifier database.

In some embodiments, the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

In some embodiments, the one or more unique characteristic identifiers comprises a fingerprint scan, wherein the randomized modification to the one or more features of the one or more unique characteristic identifiers comprises a change to a ridge or valley of the fingerprint scan.

In some embodiments, the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

In some embodiments, the identifier scrambling engine is an artificial intelligence (“AI”) engine, wherein identifying the one or more features of the one or more unique characteristic identifiers comprises performing AI-based detection of the one or more features.

In some embodiments, the randomized modification is performed using a generative AI based process.

Embodiments of the present disclosure also provide a computer-implemented method for securing electronic identity data using electronic data obfuscation and masking, the computer-implemented method comprising receiving one or more unique characteristic identifiers from an endpoint computing device; identifying, using an identifier scrambling engine, one or more features of the one or more unique characteristic identifiers; generating, using an identifier scrambling engine, a plurality of decoy identifiers based on the one or more unique characteristic identifiers, wherein each of the plurality of decoy identifiers comprises a randomized modification to the one or more features of the one or more unique characteristic identifiers; and storing the one or more unique characteristic identifiers and the plurality of decoy identifiers within a unique characteristic identifier database.

In some embodiments, the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

In some embodiments, the one or more unique characteristic identifiers comprises a fingerprint scan, wherein the randomized modification to the one or more features of the one or more unique characteristic identifiers comprises a change to a ridge or valley of the fingerprint scan.

In some embodiments, the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

In some embodiments, the identifier scrambling engine is an artificial intelligence (“AI”) engine, wherein identifying the one or more features of the one or more unique characteristic identifiers comprises performing AI-based detection of the one or more features.

In some embodiments, the randomized modification is performed using a generative AI based process.

In some embodiments, the endpoint device is a mobile device of a user, wherein the one or more unique characteristic identifiers are captured from the user through the mobile device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for securing electronic identity data using electronic data obfuscation and masking, in accordance with an embodiment of the disclosure;

FIG. 2 illustrates an exemplary machine learning subsystem architecture, in accordance with an embodiment of the invention;

FIG. 3 illustrates a method for securing electronic identity data using electronic data obfuscation and masking, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

Networked systems, computing devices, and applications are increasingly relying on the use of unique characteristic identifiers (e.g., biometric identifiers such as fingerprint data, facial feature data, voice data, and/or the like) in authenticating users and authorizing user actions. That said, the storage of raw unique characteristic identifier data (e.g., within a conventional networked database) may raise security and data privacy concerns in the event that the database is breached and/or there is an unauthorized viewing, exfiltration, and/or copying of the data stored therein. Accordingly, there is a need to improve the security of databases that may store unique characteristic data.

To address the above concerns among others, the system described herein provides a way to reduce the incidence of successful data exfiltration as well as prevent the misuse of such data in the event that the data is exfiltrated. In this regard, the system may comprise a database for storing unique characteristic data (which may also be referred to herein as the “identifier database”). The identifier database may comprise one or more entries containing a unique characteristic identifier, such as a biometric fingerprint sample, voice data sample, facial image data sample, and/or the like, where each entry may be associated with an individual or entity (e.g., a user who provided the unique characteristic data, such as a fingerprint scan). In some embodiments, the unique characteristic identifier may be stored as an encrypted file or a character string such as a hash value (e.g., a hash value generated by inputting the raw biometric data, such as fingerprint scan data, into a hash algorithm).

In addition to the genuine unique characteristic data, the identifier database may further comprise a plurality of decoy identifiers. By storing the genuine identifiers among the decoy identifiers, the system may drastically reduce the level of confidence that unauthorized parties may have that compromised characteristic data is valid or genuine. In this regard, the system may comprise an identifier scrambling engine that may generate a large number of decoy identifiers (e.g., decoy identifiers numbering in the millions, billions, trillions, and/or the like). The identifier scrambling engine may intake a sample of genuine unique characteristic data (e.g., a facial image scan, fingerprint scan, and/or the like) and generate the numerous decoy identifiers by performing one or more modifications to the unique characteristic data.

For instance, in embodiments in which the unique characteristic data is a facial image scan (e.g., a “reference” identifier), the identifier scrambling engine may perform modifications to the geometry, hue, saturation, and/or the like of the facial image scan. For example, the identifier scrambling engine may elongate or shorten certain portions of the face, change the hue of the user's features (e.g., eyes or hair), and/or the like. Accordingly, each decoy identifier may comprise one or more of the modifications made by the scrambling engine (e.g., one decoy identifier may have purple hair, another may have brown hair, and/or the like) or any combinations thereof (e.g., a shortened forehead with brown eyes, rounded cheeks with green eyes, elongated chin with purple hair, and/or the like).

In other scenarios, such as when the reference identifier is a voice data sample, the identifier scrambling engine may make modifications such as changing the pitch, cadence, amplitude, frequency, and/or other aspects of certain portions of the voice data sample. For example, a voice data sample from a user with a naturally high-pitched voice may be changed such that the voice data sample sounds as if it were taken from a user with a relatively lower-pitched voice.

In some embodiments, the identifier scrambling engine may be an AI-powered engine that may have been trained using various types of unique characteristic data (e.g., fingerprint scan data, facial scan data, voice data and/or the like) in order to generate a decoy identifier with realistic-appearing modifications. In turn, each decoy identifier may be associated with a randomly generated decoy identity. The decoy identity may include information such as a decoy name, personal identification numbers (e.g., social security numbers or the like), address, biographical information, and/or the like. By storing the genuine identifier among the numerous decoy identifiers, even in the event of a mass data exfiltration event (e.g., a leak or breach of the database), it will prove to be computationally burdensome and time-consuming for unauthorized users to identify which identifiers are the genuine identifiers.

In some embodiments, the identifiers stored within the identifier database may be encrypted or obfuscated identifiers that were generated using and/or based on genuine identifiers that may be stored offline (e.g., outside of the identifier database), such as on a secure portable device (e.g., security key, cold storage device, and/or the like). For instance, a user's facial image scan may be stored on the secure device. The system may, based on the image scan stored on the secure device, generate an obfuscated or encrypted identifier (e.g., a hash output using the reference identifier as an input) and store the generated identifier within the identifier database. In this way, in the event that the data is exfiltrated, the unauthorized party will only have access to the obfuscated or encrypted data instead of the raw characteristic data.

In some embodiments, the identifier scrambling engine may further lengthen or obfuscate each unique characteristic identifier by performing one or more modifications to the reference identifier to render the identifier illegible by ordinary methods. For instance, in cases in which the reference identifier is a fingerprint scan or facial scan, the identifier scrambling engine may overlay and/or intersperse additional data (e.g., text, images, and/or the like) within the reference data to create a scrambled identifier based on the reference identifier. Separately, the system may maintain a changelog for each scrambled identifier such that the identifier may remain usable to the system while being unusable to unauthorized parties without access to the changelog. In this regard, the changelog may be stored in a separate database and/or a separate device from that of the identifier database.

The system as described herein provides a number of technological benefits over conventional methods for masking unique characteristic data. For instance, by generating decoy identifiers using intelligently modified reference identifiers, the system may create realistic and convincing decoys, thereby reducing the chances that a genuine identifier will be successfully linked to a genuine identity by an unauthorized party. Furthermore, by using an intelligent scrambling engine to generate scrambled identifiers, the system places additional roadblocks to the unauthorized party even when the genuine identifier is successfully exfiltrated.

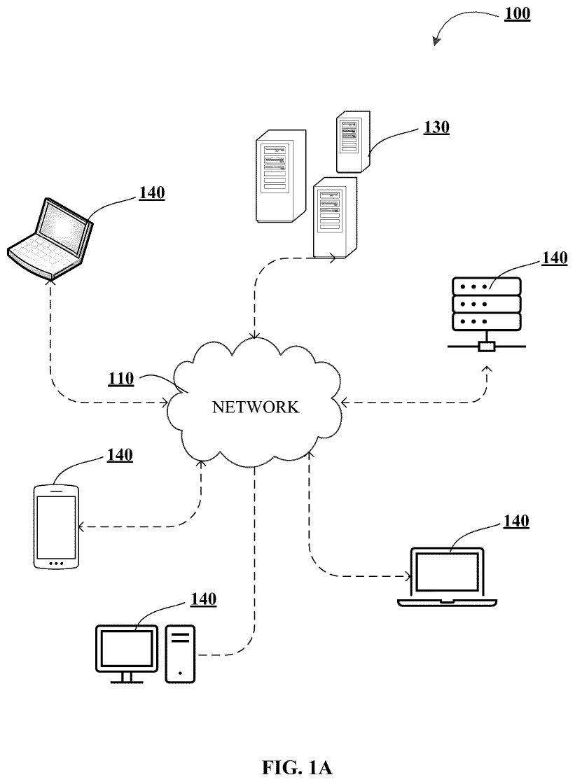

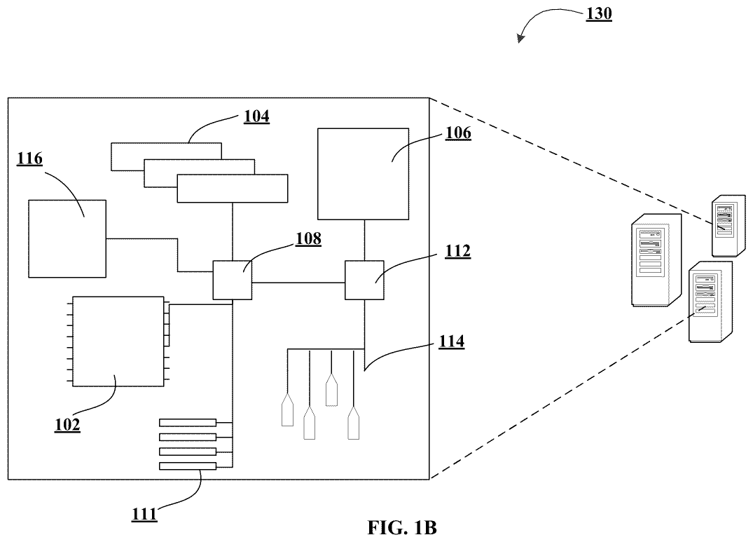

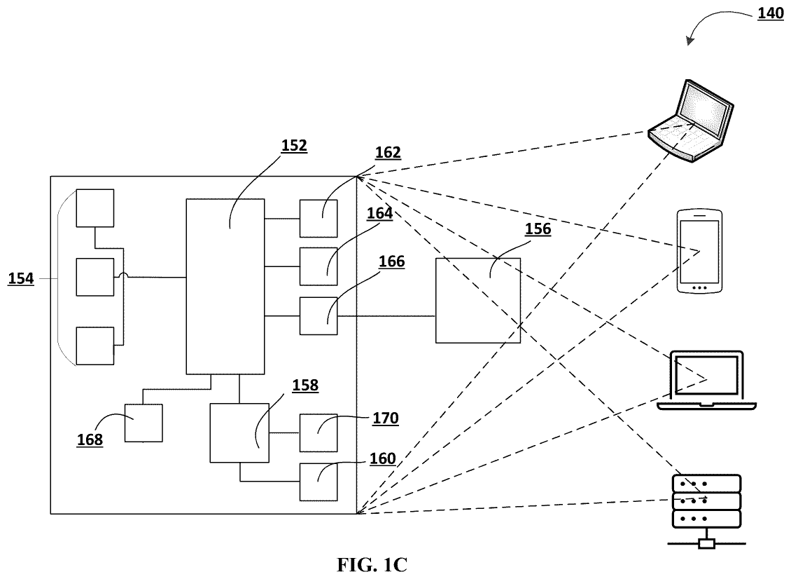

Turning now to the figures, FIGS. 1A-1C illustrate technical components of an exemplary distributed computing environment 100 for the system for securing electronic identity data using electronic data obfuscation and masking. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

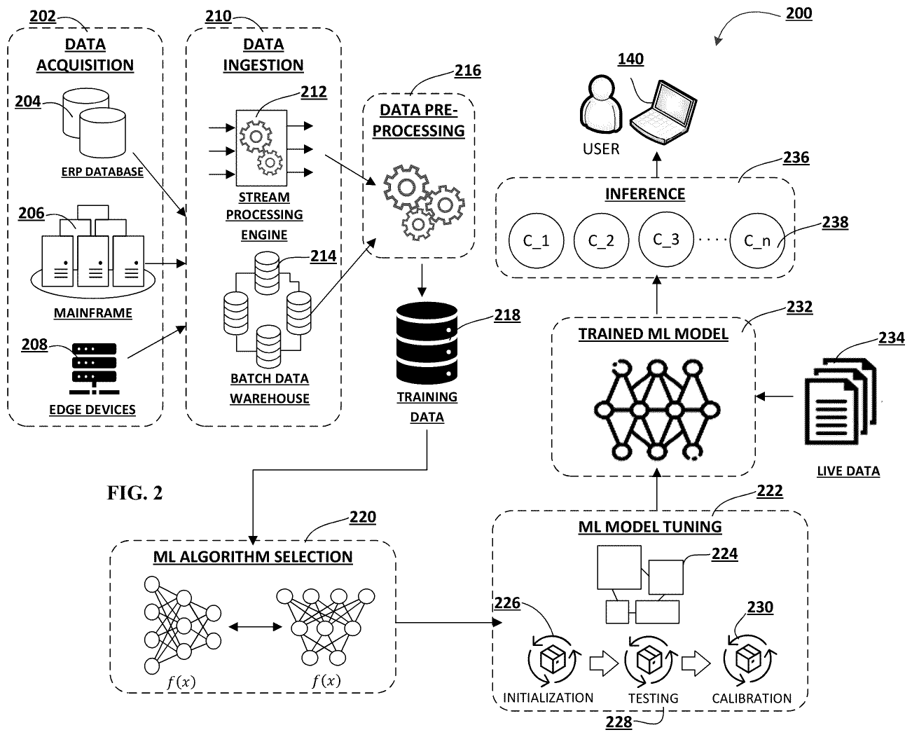

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

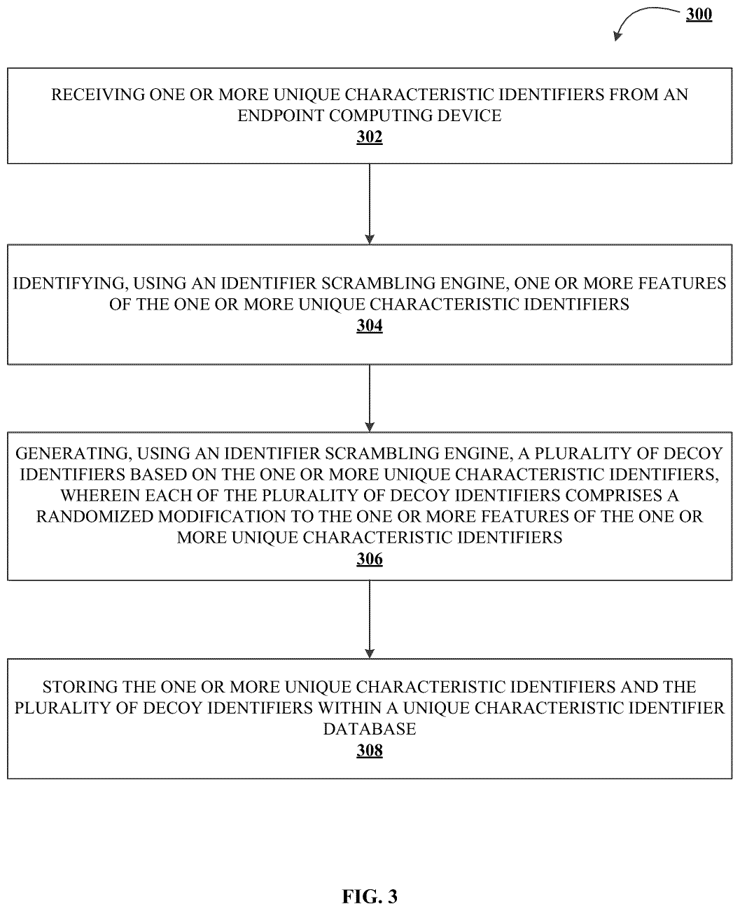

FIG. 3 illustrates a method 300 for securing electronic identity data using electronic data obfuscation and masking. As shown in block 302, the method includes receiving one or more unique characteristic identifiers from an endpoint computing device. The endpoint computing device may be, for instance, a personal computing device of the user (e.g., a smartphone or the like) that may be used to capture the unique characteristic identifier from the user (e.g., biometric data). The unique characteristic identifiers may include unique characteristic data, which may include biometric data such as a fingerprint scan, facial image scan, voice data sample, iris scan, and/or the like, which may have been provided by a user for the purposes of authentication. In this regard, the unique characteristic identifiers may subsequently be used not only for the purpose of authenticating the user, but also authorizing user actions (e.g., accessing user accounts, managing user accounts, executing transactions, and/or the like). As such, there is a need to protect the security and privacy of the unique characteristic identifiers in the event of a data exfiltration event (e.g., a data breach in which a portion of the unique characteristic data may be compromised).

Next, as shown in block 304, the method includes identifying, using an identifier scrambling engine, one or more features of the one or more unique characteristic identifiers. The features detected by the identifier scrambling engine may depend on the type of data within the unique characteristic identifier. For instance, in embodiments in which the unique characteristic identifier is a facial image scan, the features may include facial geometry (e.g., shape of forehead, hair, eyebrows, nose, cheeks, eyes, chin, jaw, and/or the like), hair length, hair color, eye color, and/or the like. In embodiments in which the unique characteristic identifier is a fingerprint scan, the features may include ridges, valleys, loops, whorls, deltas, and/or the like. In embodiments in which the unique characteristic identifier is a voice data sample, the detected features may include pitch, amplitude, timbre, cadence, tone, texture, and/or the like. It should be understood that the foregoing examples are provided for illustrative purposes only and is not intended to restrict the scope of the features of the identifier scrambling engine or any other portions of the disclosure provided herein. In some embodiments, the identifier scrambling engine may be an artificial intelligence (“AI”) based module that may have been trained using various types of training data (e.g., facial image training data, fingerprint scan training data, voice sample training data, and/or the like), which in turn may allow the identifier scrambling engine to accurately identify the relevant features to be modified as described in further detail below.

Next, as shown in block 306, the method includes generating, using an identifier scrambling engine, a plurality of decoy identifiers based on the one or more unique characteristic identifiers, wherein each of the plurality of decoy identifiers comprises a randomized modification to the one or more features of the one or more unique characteristic identifiers. In this regard, each decoy identifier may begin as a copy of a unique characteristic identifier as a baseline (which may also be referred to as a “reference identifier”). Subsequently, the identifier scrambling engine may intelligently make one or more modifications to the features of the copy of the reference identifier. For instance, if the reference identifier is a facial image scan, the system may make modifications to the facial geometry (e.g., lengthening or shortening the forehead, rounding cheeks, widening chins, and/or the like), hue and/or saturation (e.g., changing blue eyes to brown, black hair to brown, and/or the like), and/or the like. If the reference identifier is a fingerprint image scan, the modifications may include changes to the ridges or valleys of the fingerprint, addition or removal of loops or whorls, and/or the like. If the reference identifier is a voice data sample, the system may modify the pitch, timbre, cadence, accent, and/or the like of the voice data sample. In some embodiments, the performing the modifications may comprise the identifier scrambling engine use a generative AI process to intelligently perform selective modification of the features of the reference identifier, thereby creating a modified decoy identifier that appears and/or sounds natural and/or realistic.

Next, as shown in block 308, the method includes storing the one or more unique characteristic identifiers and the plurality of decoy identifiers within a unique characteristic identifier database. The system may generate multiple orders of magnitude more decoy identifiers per genuine unique characteristic identifier. Accordingly, once the decoy identifies are stored within the identifier database along with the genuine identifiers, it may become computationally impractical to identify which are the genuine identifiers that correspond to a genuine identity. In some embodiments, the unique characteristic identifiers may further be modified when stored in the identifier database. For instance, the identifier scrambling engine may run an obfuscation process on the unique character identifiers, where the obfuscation process may include interspersing one or more artifacts into the unique characteristic identifier. For instance, in cases in which the unique character identifier is an image (e.g., a fingerprint scan or facial scan), the artifact may include character strings, text, numerical strings, images, shapes, and/or the like which may be overlayed on the unique character identifier. In cases in which the unique character identifier is an audio sample, the artifact may be randomized audio data that may be interspersed among the genuine audio data.

The system may maintain a log of the operations of the obfuscation process (or “obfuscation log”), where the log may indicate the target unique characteristic identifiers along with the specific operations or artifacts used to obfuscate the target unique characteristic identifier. Subsequently, upon receiving a request to authenticate the user, the system may undo the obfuscation using the obfuscation log to generate a restored unique characteristic identifier, and compare the restored unique characteristic identifier with the live authentication data received from the user to perform authentication of the user. On the other hand, if the scrambled identifier is exfiltrated (e.g,. by an unauthorized user), the unauthorized user may not be able to access the genuine or “true” unique characteristic data without reversing the scrambling processes executed on the unique characteristic identifier.

Accordingly, in some embodiments, the system may receive a request from the endpoint computing device to perform an action requiring authorization. For instance, the user may request to log in to access a user account maintained by an entity that may host the system described herein. In this regard, the request may comprise a current or “live” unique characteristic identifier associated with a user (e.g., the user of the endpoint computing device). The system may access the identifier database and retrieve an entry corresponding to the user, where the entry may contain the previously stored unique characteristic identifier. In some embodiments, the system may detect that the stored identifier has been obfuscated, and subsequently use the obfuscation log to remove the obfuscation. In some embodiments, the unique character identifier stored in the identifier database that may be a converted unique character identifier that may be generated based on original unique character identifier data that may be stored offline (e.g., away from the identifier database), such as on an authentication device (e.g., cold storage device, the endpoint computing device, trusted third party database, and/or the like). For instance, the system may read the original unique characteristic data (e.g., fingerprint scan) may be stored on the user's mobile device and generate a derived or converted unique character identifier using the original unique character identifier as the input and performing one or more conversion processes on the input (e.g., by generating a hash output, obfuscated copy, and/or the like). Subsequently, when authenticating the user, the system may receive the current unique characteristic identifier from the user and execute the same conversion processes on the current unique characteristic identifier.

The system may then compare the current unique characteristic identifier with the one or more unique characteristic identifiers. If the system detects a match, the system may authenticate the user and authorize the requested action. However, if no match is detected, the system may determine that the user is an unauthorized user and subsequently block the user from taking the requested action. In this way, the system may provide a way to protect the security of unique characteristic data stored within the identifier database.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for securing electronic identity data using electronic data obfuscation and masking, the system comprising:
a processing device;
a non-transitory storage device containing instructions when executed by the processing device, causes the processing device to perform the steps of:
receiving one or more unique characteristic identifiers from an endpoint computing device;
identifying, using an identifier scrambling engine, one or more features of the one or more unique characteristic identifiers;
generating, using an identifier scrambling engine, a plurality of decoy identifiers based on the one or more unique characteristic identifiers, wherein each of the plurality of decoy identifiers comprises a randomized modification to the one or more features of the one or more unique characteristic identifiers; and
storing the one or more unique characteristic identifiers and the plurality of decoy identifiers within a unique characteristic identifier database.

2. The system of claim 1, wherein the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

3. The system of claim 1, wherein the one or more unique characteristic identifiers comprises a fingerprint scan, wherein the randomized modification to the one or more features of the one or more unique characteristic identifiers comprises a change to a ridge or valley of the fingerprint scan.

4. The system of claim 1, wherein the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

5. The system of claim 1, wherein the identifier scrambling engine is an artificial intelligence (“AI”) engine, wherein identifying the one or more features of the one or more unique characteristic identifiers comprises performing AI-based detection of the one or more features.

6. The system of claim 1, wherein the randomized modification is performed using a generative AI based process.

7. The system of claim 1, wherein the endpoint device is a mobile device of a user, wherein the one or more unique characteristic identifiers are captured from the user through the mobile device.

8. A computer program product for securing electronic identity data using electronic data obfuscation and masking, the computer program product comprising a non-transitory computer-readable medium comprising code causing an apparatus to perform the steps of:
receiving one or more unique characteristic identifiers from an endpoint computing device;
identifying, using an identifier scrambling engine, one or more features of the one or more unique characteristic identifiers;
generating, using an identifier scrambling engine, a plurality of decoy identifiers based on the one or more unique characteristic identifiers, wherein each of the plurality of decoy identifiers comprises a randomized modification to the one or more features of the one or more unique characteristic identifiers; and
storing the one or more unique characteristic identifiers and the plurality of decoy identifiers within a unique characteristic identifier database.

9. The computer program product of claim 8, wherein the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

10. The computer program product of claim 8, wherein the one or more unique characteristic identifiers comprises a fingerprint scan, wherein the randomized modification to the one or more features of the one or more unique characteristic identifiers comprises a change to a ridge or valley of the fingerprint scan.

11. The computer program product of claim 8, wherein the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

12. The computer program product of claim 8, wherein the identifier scrambling engine is an artificial intelligence (“AI”) engine, wherein identifying the one or more features of the one or more unique characteristic identifiers comprises performing AI-based detection of the one or more features.

13. The computer program product of claim 8, wherein the randomized modification is performed using a generative AI based process.

14. A computer-implemented method for securing electronic identity data using electronic data obfuscation and masking, the computer-implemented method comprising:
receiving one or more unique characteristic identifiers from an endpoint computing device;
identifying, using an identifier scrambling engine, one or more features of the one or more unique characteristic identifiers;
generating, using an identifier scrambling engine, a plurality of decoy identifiers based on the one or more unique characteristic identifiers, wherein each of the plurality of decoy identifiers comprises a randomized modification to the one or more features of the one or more unique characteristic identifiers; and
storing the one or more unique characteristic identifiers and the plurality of decoy identifiers within a unique characteristic identifier database.

15. The computer-implemented method of claim 14, wherein the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

16. The computer-implemented method of claim 14, wherein the one or more unique characteristic identifiers comprises a fingerprint scan, wherein the randomized modification to the one or more features of the one or more unique characteristic identifiers comprises a change to a ridge or valley of the fingerprint scan.

17. The computer-implemented method of claim 14, wherein the one or more unique characteristic identifiers comprises a facial image scan, wherein the randomized modification to the one or more features of the one or more unique characteristic identifiers comprises at least one of a change to facial geometry or a change to a hue of one or more elements of the facial image scan.

18. The computer-implemented method of claim 14, wherein the identifier scrambling engine is an artificial intelligence (“AI”) engine, wherein identifying the one or more features of the one or more unique characteristic identifiers comprises performing AI-based detection of the one or more features.

19. The computer-implemented method of claim 14, wherein the randomized modification is performed using a generative AI based process.

20. The computer-implemented method of claim 14, wherein the endpoint device is a mobile device of a user, wherein the one or more unique characteristic identifiers are captured from the user through the mobile device.
